(19) United States
(12) Patent Application Publication
(10) Pub. No.: US 2005/0018677 A1
(43) Pub. Date: Jan. 27, 2005

(54) Method and system for generating IP addresses of access terminals and transmitting messages for generation of IP addresses in an IP system

(75) Inventors: Sung-Jin Lee, Suwon-si (KR); Hyun-Jeong Kang, Seoul (KR); Chang-Hoi Koo, Seongnam-si (KR); So-Hyun Kim, Suwon-si (KR); Yeong-Moon Son, Anyang-si (KR); Jung-Je Son, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/897,830

(22) Filed: Jul. 23, 2004

(30) Foreign Application Priority Data
Jul. 23, 2003 (KR) P2003-0050658

(51) Int. Cl. H04L 12/56

(52) U.S. Cl. 370/389; 709/245

(57) ABSTRACT

A system for transmitting a message for generating an Internet Protocol version 6 (IPv6) address is provided. The system includes at least one access terminal, an access point, and a router. The access terminal transmits a first medium access control (MAC) layer connection message including its own MAC address and a fast address setup indication field to the access point. The access point receives the first MAC layer connection message from the access terminal, and determines whether a duplicate MAC address of the MAC address of the access terminal exists in the same sub-network.

### PRIORITY

This application claims priority under 35 U.S.C. § 119 to an application entitled “Method And System For Generating IP Addresses Of Access Terminals And Transmitting Messages For Generation Of IP Addresses In An IP System” filed in the Korean Intellectual Property Office on Jul. 23, 2003 and assigned Serial No. 2003-50658, the contents of which are incorporated herein by reference.

### BACKGROUND OF THE INVENTION

1. Field of the Invention

The present invention relates generally to a method and system for generating a network address of an access terminal in a packet data communication system, and in particular, to a method and system for generating an Internet Protocol version 6 (IPv6)-based IP address of an access terminal and transmitting a message for generating the IP address in an Internet Protocol system (hereinafter referred to as an “IP system”).

2. Description of the Related Art

In general, an IP system is provided for data communication between an access terminal and a communication node in a conventional wired communication network. Such IP technology based on Internet Protocol version 4 (IPv4) in the early 1980's. However, because the early IPv4 was designed without full considerating possible change in use and in the communication environment, the next generation Internet Protocol, called IPv6, for improving the conventional IPv4 technology has been in development since the mid 1990's.

A brief description will now be made of an IP address system used in the conventional IPv4 technology. The IPv4 technology supports an address system of 32 bits. Because the IPv4 technology uses the 32-bit address system, it cannot cope with the increasing number of Internet users. Therefore, in order to increase the number of available addresses, and consequently the number of users, the IPv6 technology using a 128-bit address system has been developed.

The IPv6 technology not only has simply increased a length of IP addresses assignable to subscribers but also has led to the development of several advanced IPv4-based technologies, and a typical one of them being an IP address-autoconfiguration mechanism. A description will now be made of an IPv6 address-autoconfiguration mechanism provided in the IPv6 technology.

FIG. 1 is a diagram illustrating an example of a data format of a Router Advertisement message broadcasted from a router to an access terminal in a general IPv6 system. The Router Advertisement message in FIG. 1 is used as source information for IP address-autoconfiguration in an access terminal. In addition, FIG. 1 illustrates an example of a message describing an address configuration (or generation) method for an access terminal, so a structure for address configuration in the access terminal is implied herein by way of example.

The Router Advertisement message used in the general IPv6 system is roughly divided into three parts: a Basic Header part 100, a Router Advertisement Option Header part 110, and an Option Header part 120. The Basic Header part 100 having a 40-byte size fundamentally includes basic information such as a source address and a destination address necessary for an IPv6 packet. The Router Advertisement Option Header part 110 is comprised of 12 bytes. The Router Advertisement Option Header part 110 indicates that the message of FIG. 1 is a Router Advertisement message periodically broadcasted from a router.

The Option Header part 120 can use a selected one of Source Link Layer Address, Maximum Transfer Unit (MTU), and Prefix Information according to its use. That is, the Router Advertisement message can include one of these three types of information. In FIG. 1, because the message is used for IP address configuration, the Option Header part 120 includes Prefix Information 130. Therefore, the Prefix Information has a 32-byte size, and represents an address of an IP sub-network to which the access terminal belongs.

FIG. 2 is a diagram illustrating a procedure for generating an IP address using a Router Advertisement message broadcasted from a router 290 in a general IPv6 system. The IP address is generated by access terminal 200. Referring to FIG. 2, when a user at the access terminal 200 requests an IP address or desires to perform Internet communication, terminal 200 generates a Router Solicitation message and transmits the Router Solicitation message to a corresponding router 290 in step 210. That is, the access terminal 200, when necessary, immediately generates a Router Solicitation message and transmits the Router Solicitation message to the router 290 without waiting for a Router Advertisement message periodically broadcasted by the router 290. Conversely, when the access terminal 200 doesn't need to immediately receive an IP address, or when it directly receives a Router Advertisement message from the router 290, the access terminal 200 is not required to transmit the Router Solicitation message in step 210.

No matter whether the Router Solicitation message is received or not, the router 290 transmits in step 220 a Router Advertisement message to each access terminal at a time predetermined time interval. The transmitted Router Advertisement message includes necessary information such as Source Address information included in the Basic Header part 100 of FIG. 1 to be broadcasted to access terminals connected to the same network so that all access terminals connected to the network can receive the Router Advertisement message. Therefore, the Router Advertisement message includes address information of the network, such as prefix information included in the Option Header part 120 of FIG. 1, and the access terminal 200 receiving the Router Advertisement message analyzes the received Router Advertisement message and can generate an IP address to be used in the current network to which it belongs.

Thereafter, in step 230, the access terminal 200 receiving the Router Advertisement message automatically generates (or configures) an IPv6 address based on Prefix Information 130 of FIG. 1 in the information included in the Router Advertisement message. In the method of automatically generating an IP address, the access terminal 200 generates a 128-bit IPv6 address by combining a Prefix number with its own Medium Access Control (MAC) address. The access terminal 200, generating the IPv6 address, generates an IP address by itself instead of being assigned an LP address from the router 290. Therefore, the access terminal 200 cannot determine whether the generated IP address is a duplicate of an IP address used by another access terminal.

Therefore, the access terminal 200 must determine whether its own IP address is identical to an IP address used by another access terminal. To this end, the access terminal 200 performs Duplicated Address Detection (DAD) with another access terminal in step 240. That is, the access terminal 200 generates a Duplicated Address Detection message, and broadcasts the Duplicated Address Detection message to other access terminals belonging to the same sub-network connected to the router 290. In addition, the access terminal 200 activates a timer having a predetermined time value in order to allow the other access terminals to respond to the Duplicated Address Detection message.

In step 250, the access terminal 200 waits for a response to the Duplicated Address Detection message. If no response is received from another access terminal when the timer expires, i.e., if no other access terminal transmits a message indicating that the same IP address is in use, the access terminal 200 determines that it can use the corresponding IP address. Then, in step 260, the access terminal 200 stores the generated address as an IPv6 address, and can perform packet data communication.

However, because the IPv6 technology has been designed for wired networks, its performance for use in a wireless network must be improved to prevent many possible problems. Before a description of the problems is given, a process of automatically setting up an IPv6 address by the above method in an access terminal that is part of a wireless network will be described with reference to FIG. 3.

FIG. 3 is a diagram illustrating a procedure for receiving an address assigned by a router 390 in a general IPv6 system at a wireless access terminal 300. Referring to FIG. 3, the access terminal 300 is connected to an access point (AP) 380 through a wireless channel. The AP 380 is in turn connected to router 390. In steps 305 and 310, the access terminal 300 acquires information necessary for wireless communication in a cell where the corresponding access terminal is currently located from AP 380 through a Layer 2 message such as by MAC signaling. After the registration, the access terminal 300 sets information on an IP layer which is Layer 3. That is, in the procedure of steps 305 and 310, because only physical layer information and Layer 2 information are exchanged, IP information of Layer 3 is possible after a setup (or connection) procedure for Layer 2 is completed.

Therefore, a setup (or connection) procedure for Layer 3 is performed in steps 320 and 330 through an exchange of a Router Solicitation message and/or a Router Advertisement message between the access terminal 300 and the access point 380, after steps 305 and 310 for Layer 2 are performed. The access terminal 300 then automatically generates an IPv6 address and performs Duplicated Address Detection, in a process which is identical to the corresponding process described in conjunction with FIG. 2, and is shown in steps 320 to 370.

In order for a wireless access terminal to access the Internet through an access point in a wireless network, because a Layer 2 connection procedure and a Layer 3 connection procedure are independently performed as described above, a total delay time required for the connection amounts to several seconds. In particular, when the wireless access terminal is on the move, its cell position frequently changes and an access point with which it communicates continuously changes. That is, if the wireless access terminal performs handoff while maintaining an IP communication connection, a long delay time is required. In this case, therefore, the connection of a channel may be disconnected causing remarkable deterioration of channel performance. Accordingly, there is a demand for technology capable of reducing a delay time by improving the connection procedures for wireless Internet access.

### SUMMARY OF THE INVENTION

It is, therefore, an object of the present invention to provide a method and system for rapidly generating an IPv6 address in a mobile communication system.

It is another object of the present invention to provide a method and system for rapidly acquiring an IP address during handoff of a wireless access terminal in a mobile communication system.

It is further another object of the present invention to provide a message transmission method and system for reducing an IP address acquisition time in an access terminal by previously transmitting only information necessary for Layer 2 (MAC layer) connection setup for information on Layer 3 (IP layer) which could be received after an IP communication connection is set up, in a mobile communication system.

To achieve the above and other objects, there is provided a method for generating by an access terminal an Internet Protocol (IP) address from a router when the access terminal moves into a cell occupied by the router in order to communicate with any one of a plurality of access points occupied by the router in an IP system including the router, the access points being connected to the router, and the access terminal capable of communicating with at least one of the access points. The method includes the steps of receiving medium access control (MAC) layer connection message information including a field for requesting fast address setup and a field indicating a MAC address of the access terminal from the access terminal via at least one of the access points; and upon receiving the MAC layer connection message information, including prefix information representing the same IP sub-network in the MAC layer connection message and transmitting the MAC layer connection message to the access terminal if the same MAC address as the MAC address of the access terminal does not exist in a network controlled by the router.

Further, to achieve the above and other objects, there is provided a method for transmitting a message for generating an Internet Protocol (IP) address of an access terminal in an Internet Protocol version 6 (IPv6) system including an access point wirelessly connected to the access terminal and a router for connecting the access point to an Internet. The method includes the steps of receiving a first medium access control (MAC) layer connection message including a MAC address and a fast address setup indication field from the access terminal, and determining whether a duplicate MAC address exists in the same sub-network; and transmitting to the access terminal a second MAC layer connection message including a prefix information field generated by combining a temporary MAC address of the access terminal with a prefix representing the sub-network if there is a duplicate MAC address.

Further, to achieve the above and other objects, there is provided an Internet Protocol version 6 (IPv6) system for generating an IP address. The system comprises at least one access terminal for generating a first medium access control (MAC) layer connection message including its own MAC address and a fast address setup indication field, transmitting the first MAC layer connection message to an access point of the Ipv6 system, and generating an IPv6 address by receiving a second MAC layer connection message including a prefix of its sub-network from the access point; and the access point for receiving the first MAC layer connection message from the access terminal, determining whether a duplicate MAC address of the MAC address of the access terminal exists in the same sub-network, and transmitting a second MAC layer connection message including the prefix to the access terminal, if the MAC address is unique.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating an example of a data format of a Router Advertisement message broadcasted from a router to an access terminal in a general IPv6 system;

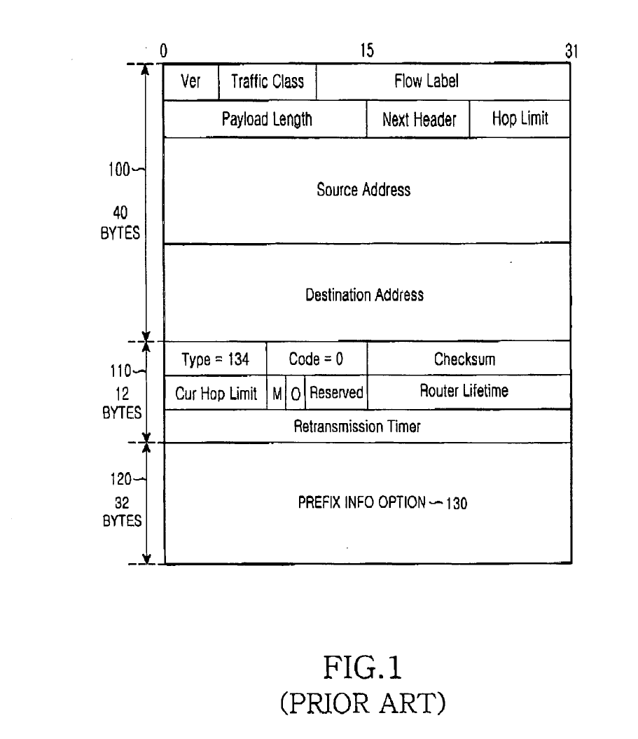

FIG. 2 is a diagram illustrating a procedure for generating by an access terminal an IP address using a Router Advertisement message broadcasted from a router in a general IPv6 system;

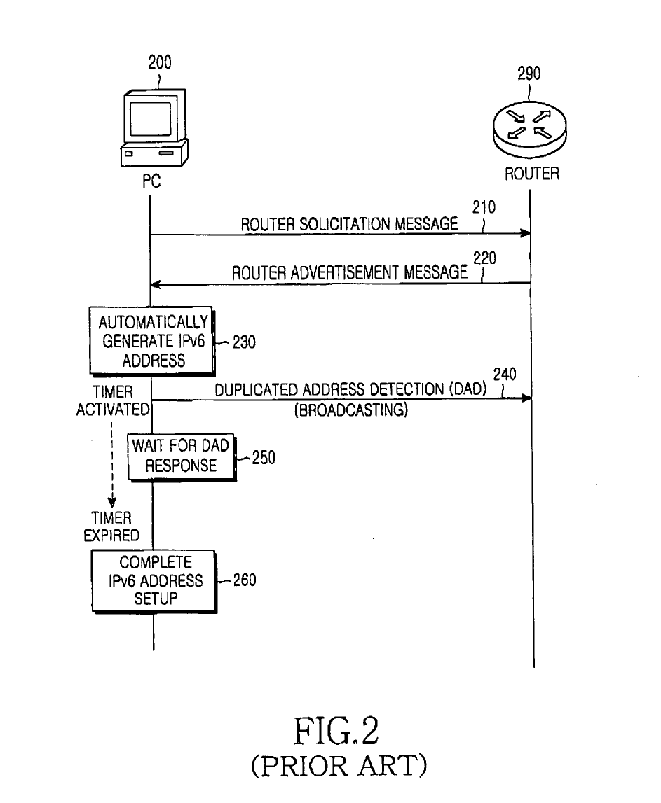

FIG. 3 is a diagram illustrating a procedure for receiving by a wireless access terminal an address assigned by a router in a general IPv6 system;

FIG. 4 is a diagram illustrating a procedure for assigning an IPv6 address for an access terminal according to an embodiment of the present invention;

FIG. 5 is a diagram illustrating an example of a data format of a first MAC layer connection message transmitted over an uplink during fast address setup according to an embodiment of the present invention;

FIG. 6 is a diagram illustrating an example of a data format of a second MAC layer connection message transmitted over a downlink during fast address setup according to an embodiment of the present invention;

FIG. 7 is a flowchart illustrating a procedure for generating an arbitrary address in an access point or a router according to an embodiment of the present invention; and

FIG. 8 is a flowchart illustrating a procedure for automatically generating an address in an access terminal upon receiving a second MAC layer connection message according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

As described in the Related Art section, conventional IP technology was used on the basis of Internet Protocol version 4 (IPv4) in the early 1980's. However, because the early IPv4 was designed without fully taking into consideration possible changes in use and in the communication environment, next generation Internet Protocol, called Internet Protocol version 6 (IPv6), for improving the conventional IPv4 technology has been under development since the mid 1990's. Although IPv6 has been developed to fully consider possible changes in use and in the communication environment, it has been designed in consideration of only a wired communication environment, rather than to include a mobile communication environment and a wireless communication environment. Therefore, in developing actual mobile Internet technology, many compatibility problems between Internet technology and mobile communication technology in providing an Internet service in an upper layer have occurred.

The present invention provides a method for rapidly automatically generating an IPv6 address in a mobile communication environment where IPv6 technology, originally designed for a wired network, supports a wireless communication environment where a limited bandwidth is used, thereby minimizing a delay time that a wireless access terminal experiences during handoff or reconnection due to its movement. In this manner, the wireless access terminal minimizes a transmission delay due to its movement even in a mobile communication environment, thereby receiving seamless service.

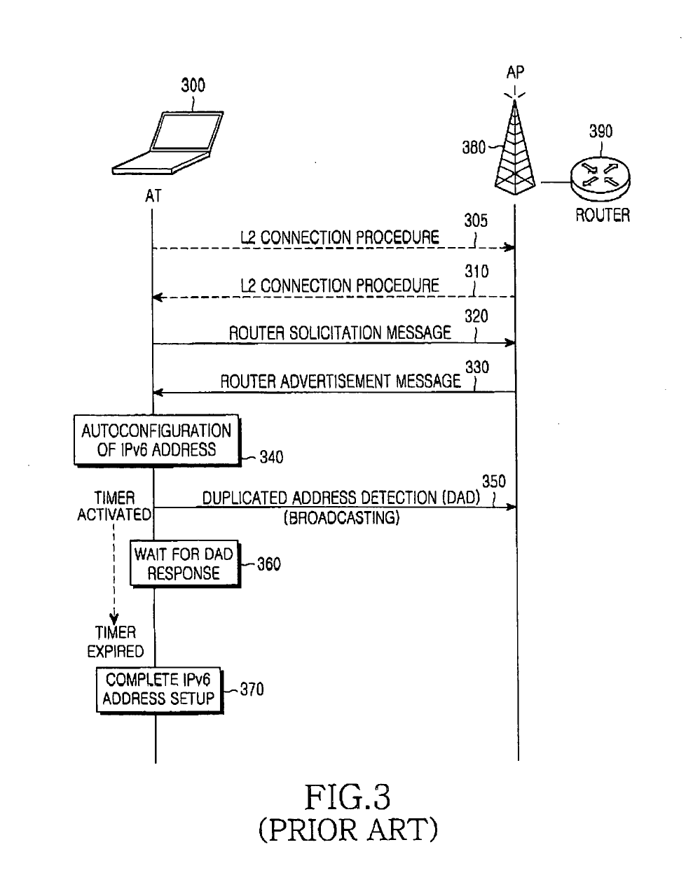

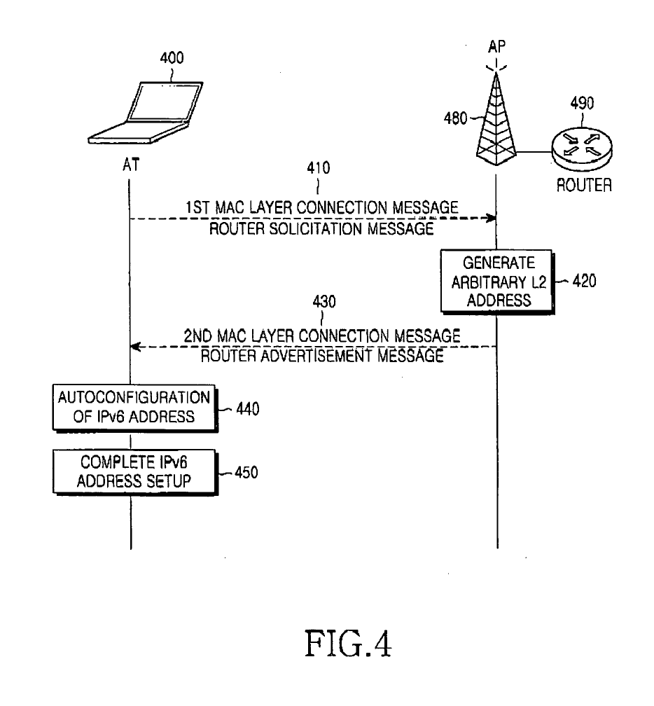

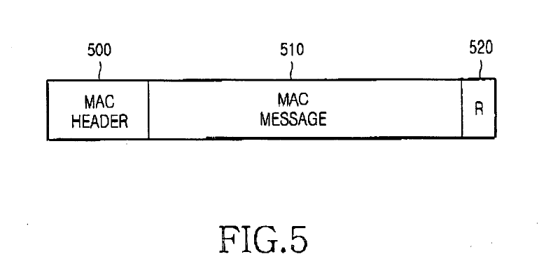

FIG. 4 is a diagram illustrating a procedure for assigning an IPv6 address for a wireless access terminal according to a preferred embodiment of the present invention. Referring to FIG. 4, when an access terminal 400 performs initial communication or is connected to a new cell, the access terminal 400 generates a Router Solicitation message according to an embodiment of the present invention and transmits the generated Router Solicitation message over an uplink in step 410. The “uplink” refers to a link from the access terminal 400 to an access point (AP) 480, a link from the access terminal 400 to a router 490, and/or from the access point 480 to the router 490. The process of transmitting the Router Solicitation message in step 410 corresponds to the Layer 2 connection procedure described in conjunction with FIG. 3. However, the Router Solicitation message includes a message newly defined according to an embodiment of the present invention. The Router Solicitation message according to an embodiment of the present invention will be described herein below with reference to FIG. 5.

FIG. 5 is a diagram illustrating an example of a data format of a first MAC layer connection message which is used as the Router Solicitation message, and which is transmitted over an uplink during fast address setup according to an embodiment of the present invention. The Router Solicitation message includes a MAC header 500 and a MAC message 510 for MAC layer data processing between the access terminal 400 and the access point 480. Further, the Router Solicitation message includes an R bit 520 prepared for fast IP address setup according to an embodiment of the present invention. If the R bit 520 is ‘1’, it means that a fast address setup procedure according to an embodiment of the present invention is requested, and if the R bit 520 is ‘0’, it means that the conventional address setup procedure is requested. In the following description, the R bit 520 will be referred to as a “fast address setup indication field.”

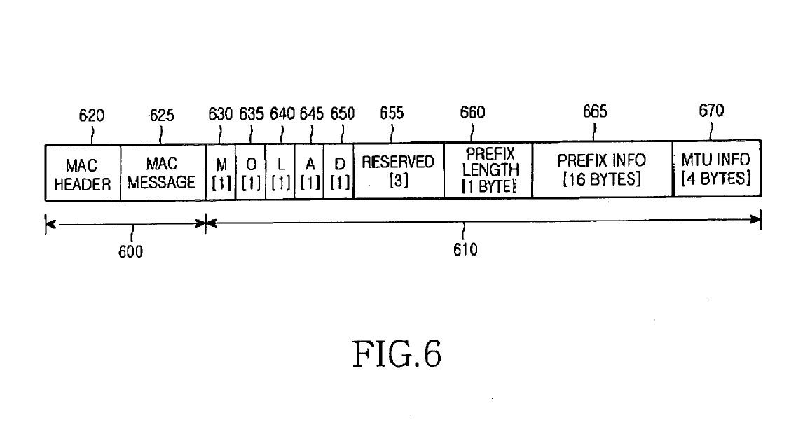

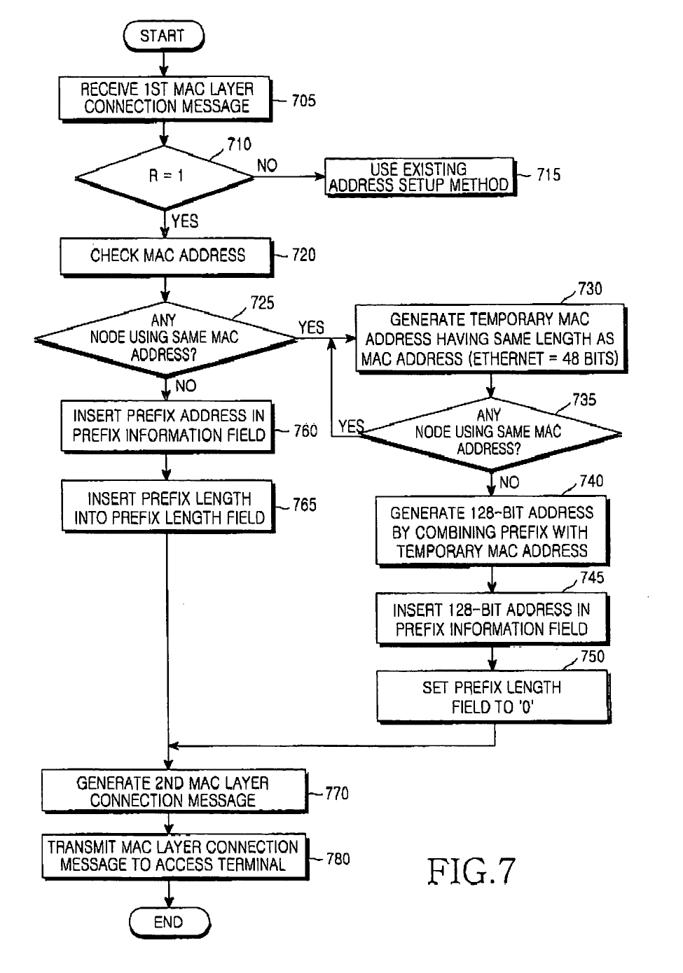

Turning back to FIG. 4, it is assumed that the fast address setup indication field (R bit 520) of FIG. 5 is set to ‘1’ before being transmitted to the access point 480. If the access terminal 400 transmits the Router Solicitation message with the set fast address setup indication field to the access point 480, the access point 480, by itself or via router 490, generates a MAC address of an access terminal (or a temporary MAC address having the same length) and/or an arbitrary Layer 2 address including a prefix for IP address generation in step 420. Access point 480 then transmits a message to the access terminal 400 over a downlink in step 430. An address generation procedure for generating the MAC Layer 2 connection message (shown in FIG. 6) will be described in detail herein below with reference to FIG. 7.

The term “downlink” used in step 430 refers to a link from the router 490 to the access point 480, a link from the router 490 to the access terminal 400, and/or a link from the access point 480 to the access terminal 400. Here, the access point 480 transmits the address generated in step 420 using a second MAC layer connection message. That is, the second MAC layer connection message is a MAC message. Such a MAC message includes a Router Advertisement message for Layer 3 connection according to an embodiment of the present invention as well as the conventional message. The message generated in step 420 will now be described in detail with reference to FIG. 6.

FIG. 6 is a diagram illustrating an example of a data format of a second MAC layer connection message transmitted over a downlink during fast address setup according to an embodiment of the present invention. Most fields shown in FIG. 6 are the equivalent of the fields used in the Router Advertisement message in the existing wired network. The message of FIG. 6 is roughly divided into two areas: a MAC area 600 and an address generation area 610. The MAC area 600 is an area for processing of a MAC layer, and the address generation area 610 is an area defined for generating an IPv6 address of the access terminal 400. The MAC area 600 includes a MAC header 620 and a MAC message 625 for processing of the MAC layer.

The address generation area 610 includes the following fields according to an embodiment of the present invention.

(1) Arbitrary Address Generation Indication Field

The arbitrary address generation indication field indicates whether the access terminal 400 will arbitrarily generate and use an IP address in the network. In FIG. 6, this field is represented with two bits: one is an M bit 630 and another is an 0 bit 635. Here, the M bit and the 0 bit have the following meanings.

If the M bit is 1, the access terminal 400 cannot use an address autoconfiguration method for arbitrarily generating an IP address, and must use an IP address assigned from the router 490 or the access point 480. However, if the M bit is 0, it means that the access point 480 or the router 490 does not restrict an operation of generating an IP address for the access terminal 400. The Dynamic Host Configuration Procedure (DHCP) refers to a server for assigning an IP address available for an access terminal located in a network, the access terminal desiring to receive setup information (e.g., subnet mask, and gateway address) other than an IP address.

In addition, if the 0 bit is 1, the access terminal 400 can generate an IP address using the address autoconfiguration method for generating an arbitrary address according to an embodiment of the present invention, but it must be assigned other information necessary in the network except an IP address for the access terminal 400, through DHCP. However, if the 0 bit is 0, it means that the access point 480 or the router 490 does not restrict an operation of generating an address for the access terminal 400, for IP address generation.

(2) Prefix Information's Link Discrimination Indication Field

This field can be used by the access terminal 400 to determine a link where it is located using prefix information in a received Router Advertisement message. This field corresponds to an L bit 640 indicating whether to use the corresponding Router Advertisement message for such a purpose. For example, if the L bit 640 is ‘1’, it indicates that prefix information received by the access terminal 400 can be used for the purpose of link discrimination. In contrast, if the L bit 640 is ‘0’, it means that the access terminal 400 cannot use the transmitted prefix information for the purpose of link discrimination.

(3) Autonomous Address Configuration Field

The autonomous address configuration field corresponds to an A bit 645 in FIG. 6, and indicates whether address autoconfiguration is possible. For example, if the A bit 645 is ‘1’, it means that it is possible to set autonomous address configuration. In contrast, if the A bit 645 is ‘0’, it indicates that it is not possible to set automatic address configuration.

(4) Duplicated MAC Header Indication Field

The duplicated MAC header indication field corresponds to a D field 650 in FIG. 6, and the access point 480 or the router 490 determines whether an access terminal using the same MAC address as a MAC address of a header in a MAC message received from access terminal 400 is located in a sub-network or a cell using the same prefix, by searching an access terminal information table in the access point 480 or the router 490, and indicates the result using the D bit 650.

For example, if the D bit value is ‘1’ (i.e., TRUE), it indicates that because there is no access terminal using the same address, and thus it is possible to use an IP address generated by the access terminal 400 without performing Duplicated Address Detection any longer. However, if the D bit value is ‘0’ (i.e., FALSE), it means that because an address cannot be used as a result of the detection of a duplicate, the access terminal 400 should use an IP address assigned by the access point 480 or the router 490 without modification rather than arbitrarily generating an IP address.

(5) Reserved Field

The reserved field 655 corresponds to fields undefined in the present invention, and is comprised of 3 bits. Therefore, the reserved field 655 remains unused in order to provide for additional functions in the future. In addition, all bits in the reserved field are set to ‘0’ before being transmitted.

(6) Prefix Length Field

The prefix length field corresponds to a field 660 representing length information of a prefix used for address generation in the access terminal 400, and can be set in a 1-byte size.

(7) Prefix Information Field

This is a field for transmitting prefix information 665 for generating an IP address by the access terminal 400 in a network or transmitting an IP address set in the network, and preferably comprised of 16 bytes (128 bits).

If a value (or D bit) of the duplicated MAC header indication field 650 is ‘0’, because there is another access terminal having a duplicated address, the access terminal 400 uses the 16-byte prefix information field as an IP address assigned from the access point 480. However, if a value (or D bit) of the duplicated MAC header indication field 650 is ‘1’, the access terminal 400 uses information with a length defined by the prefix length field from the most significant bit (MSB) in the 128-bit information of the prefix information field as a prefix for generating its own IP address.

That is, a length of an IP address generated in an access terminal can be fixed to 128 bits, or a length of the prefix can be variable. Therefore, a 128-bit IP address has a prefix located in its high-bit part, a 48-bit MAC address located in its low-bit part, and ‘0’ bits located between the prefix and the MAC address.

(8) Maximum Transfer Unit Information Field

This corresponds to a field 670 for defining a maximum transfer unit (MTU) value that should be considered during information transmission by the access terminal 400 in the network, and is preferably comprised of 4 bytes.

Referring back now to FIG. 4, the second MAC layer connection message described above is transmitted from the access point 480 to the access terminal 400 in step 430. If a message for a Layer 2 connection procedure including a Router Advertisement message is received, the access terminal 400 analyzes field values of the received message and automatically generates an IPv6 address in step 440. If an IPv6 address is not automatically set up in the second MAC layer connection message but an address designated in the network is used, the access terminal 400 proceeds to step 450 without performing the IPv6 address generation process of step 440. In step 450, the access terminal 400 uses the received IPv6 address as its own address. After completing the address setup, the access terminal 400 can perform packet data communication.

FIG. 7 is a flowchart illustrating a procedure for generating an arbitrary address in an access point or a router according to an embodiment of the present invention. For convenience, it will be assumed herein that the procedure is performed in an access point 480. However, it should be noted that the procedure can be performed in a router 490, or performed in both the access point 480 and the router 490.

Referring to FIG. 7, in step 705, the access point 480 receives a first MAC layer connection message including a Router Solicitation message described in step 410 of FIG. 4. In step 710, the access point 480 analyzes a final fast address setup indication field (or R bit 520) in the Router Solicitation message of FIG. 5. If it is determined in step 710 that the fast address setup indication field is set to ‘0’, the access point 480 proceeds to step 715 where it sets up an IP address of an access terminal 400 in the conventional address setup method. However, if it is determined in step 710 that the fast address setup indication field is set to ‘1’, the access point 480 proceeds to step 720 where it sets up an IP address of the access terminal 400 in the address setup method according to an embodiment of the present invention.

In step 720, the access point 480 analyzes a MAC address in a first MAC layer connection message including the Router Solicitation message. In step 725, the access point 480 searches a neighbor list table and determines whether the same MAC address is in use in the same sub-network. If it is determined in step 725 that there is a node using the same MAC address, the access point 480 proceeds to step 730 where it generates a temporary MAC address having a length of the corresponding MAC address. Generally, Ethernet uses a 48-bit MAC address. Therefore, an access point connected to Ethernet uses a temporary 48-bit MAC address.

Thereafter, the access point 480 determines in step 735 whether the MAC address arbitrarily generated in step 730 is a duplicate. If it is determined that there is the same MAC as even in the Duplicated Address Detection, the access point 480 repeats steps 730 and 735. If a non-duplicated MAC address is generated through steps 730 and 735, the access point 480 proceeds to step 740 where it generates a 128-bit IPv6 address by combining the prefix with the generated MAC address. Thereafter, in step 745, the access point 480 inserts the generated 128-bit address into a prefix information field in the second MAC layer connection message to be transmitted to the access terminal 400. In step 750, the access point 480 sets the prefix length field 660 of the MAC frame described in FIG. 6 to ‘0’, and sets a duplicated MAC header indication field 650 (or D bit) to ‘0’ indicating that there is no duplicated address, and then proceeds to step 770.

If it is determined in step 725 that the same address is not detected, the access point 480 proceeds to step 760 where it inserts a prefix representing a corresponding sub-network address into the prefix information field 665 of FIG. 6. In step 765, the access point 480 inserts the generated prefix length information in the prefix length information field 660, and then proceeds to step 770. In step 770, the access point 480 assembles the generated fields of FIG. 6 with a MAC message. In step 780, the access point 480 transmits the second MAC layer connection message to the access terminal 400 over a downlink at step 430 of FIG. 4.

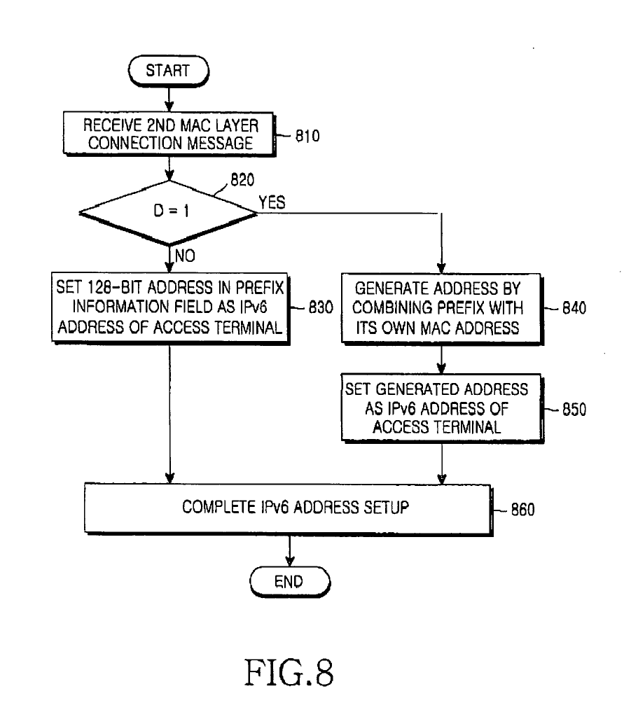

FIG. 8 is a flowchart illustrating a procedure for automatically generating an address in an access terminal upon receiving a second MAC layer connection message according to an embodiment of the present invention. Referring to FIG. 8, in step 810, an access terminal 400 receives a second MAC layer connection message, generated by an access point 480 or a router 490 in step 430 of FIG. 4, via the access point 480. In step 820, the access terminal 400 analyzes a D bit value in the duplicated MAC header indication field 650 of the received second MAC layer connection message. If it is determined in step 820 that the D bit is ‘1’, the access terminal 400 proceeds to step 840 where it automatically generates an IPv6 address by combining a prefix given in a prefix information field 665 with its own MAC address. Thereafter, in step 850, the access terminal 400 sets the address generated in step 840 as its own IP address.

However, if it is determined in step 820 that the D bit is ‘0’, the access terminal 400 cannot arbitrarily generate an IP address. In this case, the access terminal 400 sets a 128-bit address given in the prefix information field 665 as its own IPv6 address rather than a prefix. That is, if the D bit is ‘1’, i.e., if there is no access terminal using a duplicated address, the prefix information field 665 carries only a prefix. However, if the D bit is set to ‘0’, i.e., if there is an access terminal using a duplicated address, the prefix information field 665 carries the 128-bit address including the temporary MAC address and the prefix.

After step 830 or 850, the access terminal 400 completes the IPv6 address setup process in step 860. Then, the access terminal 400 can perform packet data communication with the IPv6 address described in connection with FIG. 4.

As is understood from the foregoing description, the proposed method can rapidly set up an IPv6 address of an access terminal without performing several complicated processes, thereby preventing a waste of bandwidth and maintaining quality-of-service (QoS) even during handoff.

While the invention has been shown and described with reference to a certain preferred embodiment thereof, it will be understood by those skilled in the art that various changes in form and details may be made therein without departing from the spirit and scope of the invention as defined by the appended claims.

1. A method for generating an Internet Protocol (IP) address by an access terminal in an IP system including a router, when the access terminal moves into a cell occupied by the router in order to communicate with any one of a plurality of access points in the cell, the access points being connected to the router, and the access terminal being capable of communicating with at least one of the access points, the method comprising the steps of:
receiving, at the router, medium access control (MAC) layer connection message information including a field for requesting fast address setup and a field indicating a MAC address of the access terminal from the access terminal via at least one of the access points; and
upon receiving the MAC layer connection message information, including prefix information representing a same IP sub-network in the MAC layer connection message, transmitting, from the router, the MAC layer connection message to the access terminal if the same MAC address as the MAC address of the access terminal does not exist in a network controlled by the router.

2. The method of claim 1, further comprising the step of, upon receiving the MAC layer connection message information, including a field generated by combining the prefix information with a temporary MAC address generated having the same length as a length of the MAC address of the access terminal, in the MAC layer connection message, transmitting, from the router, the MAC layer connection message to the access terminal if the same MAC address as the MAC address of the access terminal exists in the network controlled by the router.

3. A method for generating an Internet Protocol (IP) address of an access terminal in an IP version 6 (IPv6) system including an access point wirelessly connected to the access terminal, and a router for connecting the access point to an Internet, the method comprising the steps of:
receiving a first medium access control (MAC) layer connection message including a MAC address and a fast address setup indication field from the access terminal;
determining whether a duplicate MAC address of the MAC address of the access terminal exists in a same sub-network, if the fast address setup indication field is set;
transmitting a second MAC layer connection message including prefix information representing the sub-network to the access terminal, if the MAC address is unique; and
generating by the access terminal an IPv6 address according to information included in the second MAC layer connection message.

4. The method of claim 3, wherein the second MAC layer connection message further includes a field indicating whether the MAC address of the access terminal is a duplicate of the MAC address before being transmitted.

5. The method of claim 4, wherein the step of generating an IPv6 address comprises the step of generating, by the access terminal, the prefix information and the IPv6 address if the MAC address of the access terminal is unique.

6. The method of claim 3, wherein the second MAC layer connection message is generated by the access point.

7. The method of claim 3, wherein the second MAC layer connection message is generated by the router.

8. The method of claim 3, wherein the step of receiving a first MAC layer connection message further comprises the step of, if a duplicate MAC address exists in the sub-network, generating a field by combining a prefix of the sub-network with a temporary MAC address having the same length as the MAC address of the access terminal, including the field in the second MAC layer connection message, and transmitting the second MAC layer connection message to the access terminal.

9. The method of claim 8, wherein the step of generating an IPv6 address further comprises the step of using by the access terminal information on a field generated by combining the temporary MAC address with the prefix as the IPv6 address if there is a duplicate MAC address.

10. The method of claim 3, wherein the receiving determining, transmitting and generating steps are performed during a handoff procedure of the access terminal.

11. The method of claim 3, wherein the receiving determining, transmitting and generating steps are performed during a reconnection procedure by the access terminal.

12. An Internet Protocol version 6 (IPv6) system for generating an IP address, comprising:
at least one access terminal for generating a first medium access control (MAC) layer connection message including its own MAC address and a fast address setup indication field, transmitting the first MAC layer connection message to an access point of the Ipv6 system, and generating an IPv6 address by receiving a second MAC layer connection message including a prefix of its sub-network from the access point; and
the access point for receiving the first MAC layer connection message from the access terminal, determining whether a duplicate MAC address of the MAC address of the access terminal exists in the same sub-network, and transmitting a second MAC layer connection message including the prefix to the access terminal, if the MAC address is unique.

13. The IPv6 system of claim 12, wherein if a duplicate MAC address of the MAC address of the access terminal exists in the sub-network, the access point a field generated by combining a prefix of the sub-network with a temporary MAC address having the same length as the MAC address of the access terminal, inserts the field in the second MAC layer connection message, and transmits the second MAC layer connection message to the access terminal.

14. The IPv6 system of claim 13, wherein if there is a duplicate MAC address of the MAC address of the access terminal, the access terminal uses, as the IPv6 address, information on a field generated by combining the temporary MAC address with the prefix.

15. The IPv6 system of claim 12, wherein the second MAC layer connection message transmitted from the access point further includes a field indicating whether the MAC address of the access terminal is a duplicate MAC address.

16. An Internet Protocol version 6 (IPv6) system for generating an Internet Protocol (IP) address, comprising:
at least one the access terminal for generating a first medium access control (MAC) layer connection message including its own MAC address and a fast address setup indication field, transmitting the first MAC layer connection message to a router via an access point of the IPv6 system, and generating the IPv6 address by receiving a second MAC layer connection message including a prefix of its sub-network from the router; and
the router for receiving the first MAC layer connection message from the access terminal, determining whether a duplicate MAC address of the MAC address of the access terminal exists in the same sub-network, and transmitting a second MAC layer connection message including the prefix to the access terminal if the MAC address is unique.

17. The IPv6 system of claim 16, wherein if a duplicate MAC address of the MAC address of the access terminal exists in the sub-network, the router generates a field by combining a prefix of the sub-network with a temporary MAC address having the same length as the MAC address of the access terminal, inserts the field in the second MAC layer connection message, and transmits the second MAC layer connection message to the access terminal.

18. The IPv6 system of claim 17, wherein if there is a duplicate MAC address of the MAC address of the access terminal, the access terminal uses, as the IPv6 address, information on a field generated by combining the temporary MAC address with the prefix.

19. The IPv6 system of claim 16, wherein the second layer connection message transmitted from the router further includes a field indicating whether a MAC address of the access terminal is a duplicated MAC address.

20. A method for transmitting a message for generating an Internet Protocol (IP) address of an access terminal in an Internet Protocol version 6 (IPv6) system including an access point wirelessly connected to the access terminal and a router for connecting the access point to an Internet, the method comprising the steps of:
receiving a first medium access control (MAC) layer connection message including a MAC address and a fast address setup indication field from the access terminal, and determining whether a duplicate MAC address of the MAC address exists in the same sub-network; and
transmitting a second MAC layer connection message including a prefix information field generated by combining temporary MAC address of the access terminal with a prefix representing a sub-network to the access terminal.

21. The method of claim 20, wherein the first MAC layer connection message is a message generated by including the fast address setup indication field in a router solicitation message transmitted from the access terminal to an upper layer of a network.

22. The method of claim 20, wherein the second MAC layer connection message includes a first area including a MAC header and a MAC message for processing of a MAC layer and a second area including the prefix.

23. The method of claim 22, wherein the second area further includes an arbitrary address generation field indicating whether the access terminal will arbitrarily generate the IP address.

24. The method of claim 22, wherein the second area further includes a field indicating whether the access terminal can use the prefix for the purpose of link discrimination.

25. The method of claim 22, wherein the second area further includes a field indicating whether the MAC address of the access terminal is a duplicate MAC address in the same sub-network.

26. The method of claim 22, wherein the second area further includes a field indicating length information of the prefix.

27. The method of claim 26, wherein if a MAC address of the access terminal is unique in the sub-network, the access terminal uses as much information as a length defined in the prefix length information in the prefix information field as a prefix combined with a MAC address to generate its own IP address.

28. The method of claim 22, wherein if there is a duplicate MAC address, the access terminal uses information generated by combining the temporary MAC address with the prefix as the IPv6 address.

29. A system for transmitting a message for generating an Internet Protocol version 6 (IPv6) address, comprising:
at least one access terminal for transmitting a first medium access control (MAC) layer connection message including its own MAC address and a fast address setup indication field to an access point; and
the access point for receiving the first MAC layer connection message from the access terminal, and determining whether a duplicate MAC address of the MAC address of the access terminal exists in the same sub-network.

30. The system of claim 29, wherein if it is determined that the MAC address is unique, the access point transmits a second MAC layer connection message including the MAC address of the access terminal and a prefix to the access terminal, and generates an IPv6 address based on the second MAC layer connection message.

31. The system of claim 29, wherein if it is determined that there is a duplicate MAC address, the access point generates a temporary MAC address having the same length as a MAC address of the access terminal and transmits to the access terminal a second MAC layer connection message including 128-bit address information generated by combining the temporary MAC address with a prefix representing the sub-network, and the access terminal uses the 128-bit address information as the IPv6 address.

32. A system for transmitting a message for generating an Internet protocol version 6 (IPv6) address, comprising:
at least one access terminal for transmitting a first medium access control (MAC) layer connection message including its own MAC address and a fast address setup indication field to a router; and
the router for receiving the first MAC layer connection message from the access terminal, and determining whether a duplicate MAC address of the MAC address of the access terminal exists in the same sub-network.

33. The system of claim 32, wherein if it is determined that the MAC address is unique, the router transmits a second MAC layer connection message including a prefix representing the sub-network to the access terminal, and the access terminal generates an IPv6 address based on the second MAC layer connection message.

34. The system of claim 32, wherein if it is determined that the duplicated MAC address exists in the same sub-network, the router generates a temporary MAC address having the same length as the MAC address of the access terminal and transmits to the access terminal a second MAC layer connection message including 128-bit address information generated by combining the temporary MAC address with a prefix representing the sub-network, and the access terminal uses the 128-bit address information as the IPv6 address.
